(19) United States
(12) Patent Application Publication
(10) Pub. No.: US 2003/0115363 A1
(43) Pub. Date: Jun. 19, 2003

(54) Method and apparatus for packaging a trimmed object graph

(76) Inventors: Peter A. Yared, San Francisco, CA (US); Bruce K. Daniels, Capitola, CA (US); Robert N. Goldberg, Emerald Hills, CA (US); Yury Kamen, Foster City, CA (US); Syed M. Ali, Sunnyvale, CA (US)

Correspondence Address: ROSENTHAL & OSHA L.L.P., Suite 2800, 1221 McKinney Avenue, Houston, TX, 77010, US

(21) Appl. No.: 10/010,225

(22) Filed: Dec. 6, 2001

(51) Int. Cl. G06F 15/16

(52) U.S. Cl. 709/246; 709/219

(57) ABSTRACT

A method for packaging an object graph including receiving a usage variable specification that includes a set of usages each usage specifying an attribute of an object in the object graph, creating a transient object graph representation containing the attribute specified in the variable usage specification, and packaging the transient object graph representation.

### BACKGROUND OF INVENTION

1. Field of the Invention

The invention relates generally to object technology. More specifically, the invention relates to a mechanism for packaging objects for transport over a network link or storage on a storage medium.

2. Background Art

An “object graph” is a collection of related objects which are represented in forms including binary, text, XML (“Extensible Markup Language”), etc. FIG. 1 illustrates a class diagram. The class diagram 3 represents the classes that may be present in a given object graph, attributes associated with the classes, the relationships between the classes, and associated accessors. Further, the class diagram 3 encapsulates the class definitions necessary to create the class. For example, the class diagram in FIG. 1 contains a Purchase_Order class 2 with a PURCHASE_ORDER_ID attribute. The Purchase_Order class 2 is related to a LineItem class 4 with a one-to-many relationship. Further, the Purchase_Order class 2 contains an accessor, LineItems, for the relationship to the LineItem class 4. The LineItem class 4 contains an LINEITEM_ID attribute, a QUANTITY attribute, and a DISCOUNT attribute. Further, the LineItem class 4 contains an accessor, Product, for the relationship to the Product class 6, and an accessor, Purchase_Order, for the relationship to the Purchase_Order class 2. The LineItem class 4 is related to a Product class 6 with a one-to-one relationship. The Product class 6 contains a PRODUCT_ID attribute, a NAME attribute, and a PRICE attribute.

The class diagram 3, illustrated in FIG. 1, may be used to create numerous object graphs that conform to the class diagram. For example, FIG. 2 illustrates an exemplary object graph 8 that conforms to the class diagram (3 in FIG. 1). The object graph 8 contains a Purchase_Order_Object_1 10 that contains a PURCHASE_ORDER_ID attribute. The Purchase_Order_Object_1 10 is related to three LineItem objects 11, 12, and 13. As specified by the class diagram 3 each LineItem object 11, 12, and 13 contains a LINEITEM_ID attribute, a NAME attribute and a PRICE attribute. Each LineItem object 11, 12, 13 is related to one Product object. For example, LineItem_Object_1 13 is related to Product_Object_1 14, LineItem_Object_2 12 is related to Product_Object_2 15, and LineItem_Object_3 11 is related to Product_Object_2 15. As specified by the class diagram 3 each Product object 14, 15 contains a PRODUCT_ID attribute, a NAME attribute, and a PRICE attribute. The Purchase_Order_Object_1 10 may be called the root of the object graph 8 because the Purchase_Order_Object_1 10 (explicitly or implicitly) references all objects in the object graph 8 and is the entry point into the object graph 8.

It is common practice in object technology to package objects for transport to another address space or for storage on a storage medium (such as a hard disk, removable medium, etc). One of the reasons for transporting an object to another address spaces is to execute a remote method that takes the object as a parameter. Each object package includes the object of interest along with the other objects in the object graph containing the object of interest. The reason for including the other objects in the package is to preserve the relationship between the objects. The process of packaging an object graph typically involves saving the state of each object in the object graph as a sequence of bytes that can be rebuilt into a live object at a later time. There are generic solutions that package an entire object graph. However, packaging an entire object graph for transport can be inefficient when only a subset of the object graph is required by the client process, and especially when the object graph is very complex, i.e., includes references to numerous objects.

As an example, FIG. 3 illustrates a trimmed version of the object graph 8 that is actually needed by a client process. Note that only a few of the attributes shown in FIG. 2 are needed by the client process. In this case, it would be inefficient to send the large object graph shown in FIG. 2 when all that is really needed is the small object graph shown in FIG. 3.

Still referring to FIG. 3, the subset of object graph 8, includes the primary key for each object within in the object graph e.g., the primary key for the Purchase_Order_Object_1 8′ is “PURCHASE_ORDER_ID.” Additionally, some objects also include a secondary key. Typically, object graphs require that objects within the graph all include their primary key. Depending on the database requirements the secondary key may also be required.

Programmers are often forced to create transient object graphs that contain only the required data (attributes and methods), which is time consuming. These transient object graphs are application-dependent and require the programmers to know before runtime how the client process will use the objects. Moreover, the programmers have to manually insert the transient object graphs into the applications, which makes the applications difficult to maintain.

### SUMMARY OF INVENTION

In general, in one aspect, the present invention relates to a method for packaging an object graph comprising receiving a usage variable specification that includes a set of usages each usage specifying an attribute of an object in the object graph, creating a transient object graph representation containing the attribute specified in the variable usage specification; and packaging the transient object graph representation.

In general, in one aspect, the present invention relates to a method for packaging an object graph, comprising receiving a usage variable specification that includes a set of usages each usage specifying an attribute of an object in the object graph, creating a transient object graph representation containing the attribute specified in the variable usage specification, packaging the transient object graph representation, and converting the transient object graph representation into a form suitable for transport over a network link.

In general, in one aspect, the present invention relates to a method for packaging an object graph, comprising receiving a usage variable specification that includes a set of usages each usage specifying an attribute of an object in the object graph, creating a transient object graph representation containing the attribute specified in the variable usage specification, packaging the transient object graph representation, and converting the transient object graph representation into a form suitable for storage on a storage medium.

In general, in one aspect, the present invention relates to a transport packager, comprising means for receiving a usage variable specification that includes a set of usages each usage specifying an attribute of an object in the object graph, means for creating a transient object graph representation containing the attribute specified in the variable usage specification, and means for packaging the transient object graph representation.

In general, in one aspect, the present invention relates to a computer-readable medium having recorded thereon instructions executable by a processor, the instructions for receiving a usage variable specification that includes a set of usages each usage specifying an attribute of an object in the object graph creating a transient object graph representation containing the attribute specified in the variable usage specification; and packaging the transient object graph representation.

In general, in one aspect, the present invention relates to a computer-readable medium having recorded thereon instructions executable by a processor, the instructions for receiving a usage variable specification that includes a set of usages each usage specifying an attribute of an object in the object graph, creating a transient object graph representation containing the attribute specified in the variable usage specification, packaging the transient object graph representation, and instructions for converting each trimmed object into a form suitable for transport over a network link.

In general, in one aspect, the present invention relates to a computer-readable medium having recorded thereon instructions executable by a processor, the instructions for receiving a usage variable specification that includes a set of usages each usage specifying an attribute of an object in the object graph creating a transient object graph representation containing the attribute specified in the variable usage specification packaging the transient object graph representation, and instructions for converting each trimmed object into a form suitable for storage on a storage medium.

In general, in one aspect, the present invention relates to a distributed system having a client and a server, comprising an object generator interposed between the client and the server, the object generator having a capability to trim an object graph such that the trimmed object graph contains only the attributes specified in a variable usage specification, and means for converting the transient object graph representation into a form suitable for transport over a network link between the client and the server.

In general, in one aspect, the present invention relates to an apparatus for packaging an object graph, comprising means for receiving a usage variable specification that includes a set of usages each usage specifying an attribute of an object in the object graph, means for creating a transient object graph representation containing the attribute specified in the variable usage specification, and means for packaging the transient object graph representation.

Other features and advantages of the invention will be apparent from the following description and the appended claims.

### BRIEF DESCRIPTION OF DRAWINGS

FIG. 1 illustrates a class diagram.

FIG. 2 illustrates an exemplary object graph created using the class diagram of FIG. 1.

FIG. 3 illustrates an exemplary trimmed object graph of FIG. 2.

FIG. 4 shows a transport packager according to an embodiment of the invention.

FIG. 5 shows transport packager in a client-server environment.

### DETAILED DESCRIPTION

A transport packager consistent with the principles of the invention trims an object graph so that only the required subset of the object graph is packaged for transport or storage. The transport packager uses a variable usage specification to determine the exact portions of the object graph to be packaged for transport or storage.

In the following detailed description of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

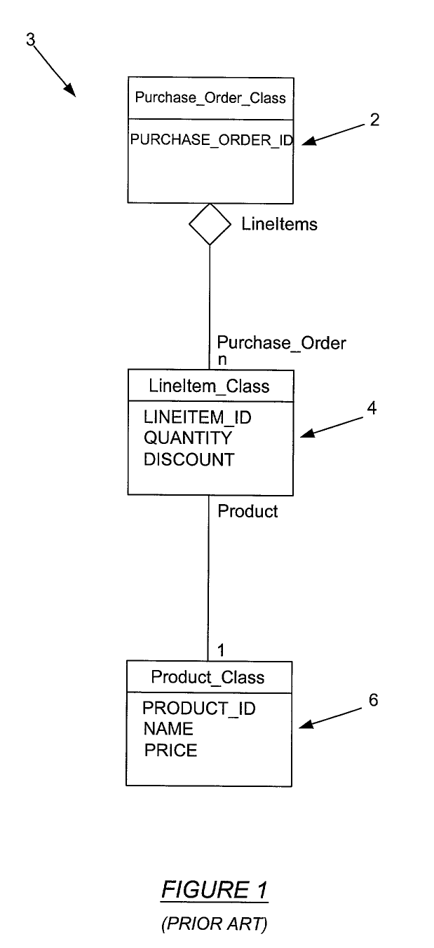

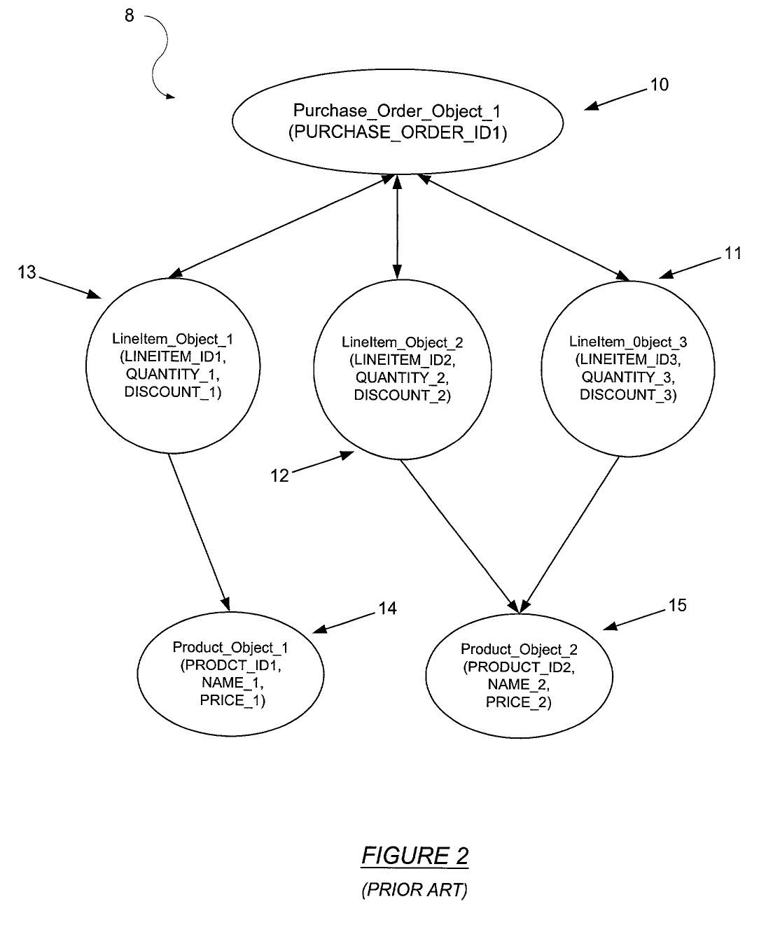

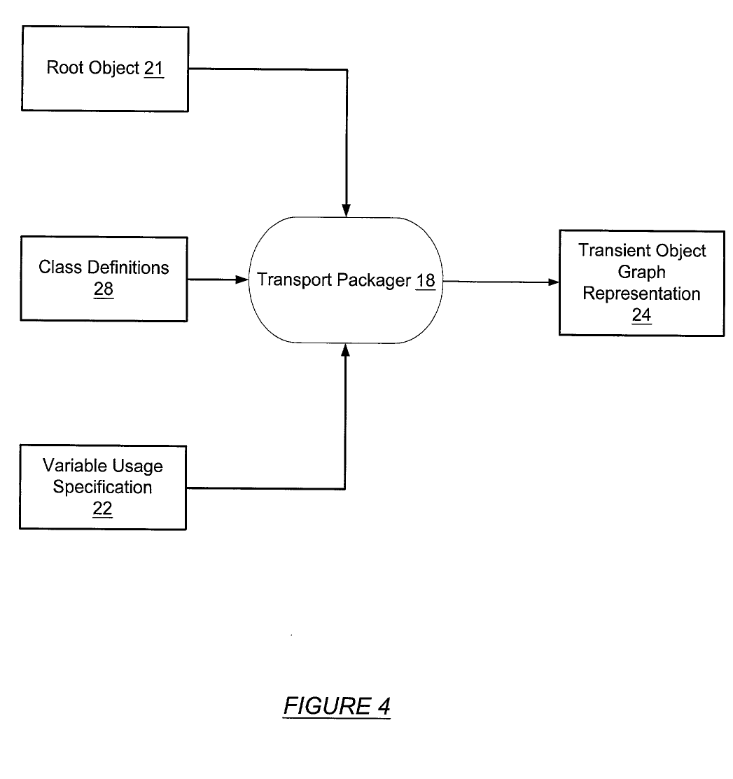

FIG. 4 shows a transport packager 18 according to an embodiment of the invention. The transport packager 18 takes a root object 21 (or reference to the root object), e.g., root object 10 in FIG. 2, a class definition 28 as encapsulated by the class diagram, and a variable usage specification 22 as input and generates a transient object graph representation 24 that contains only the properties specified in the variable usage specification 22. The transient object graph representation 24 contains the necessary information to instantiate a transient object graph in a form that may be transported across a network. The process of instantiating encompases both updating existing objects within an object graph as well as creating/deleting portions of the object graph. The transport packager 18 follows the root object 21 to transverse the object graph (2 in FIG. 1). The variable usage specification 22 specifies the attributes to be transported to a client process (not shown) or stored on a storage medium (not shown).

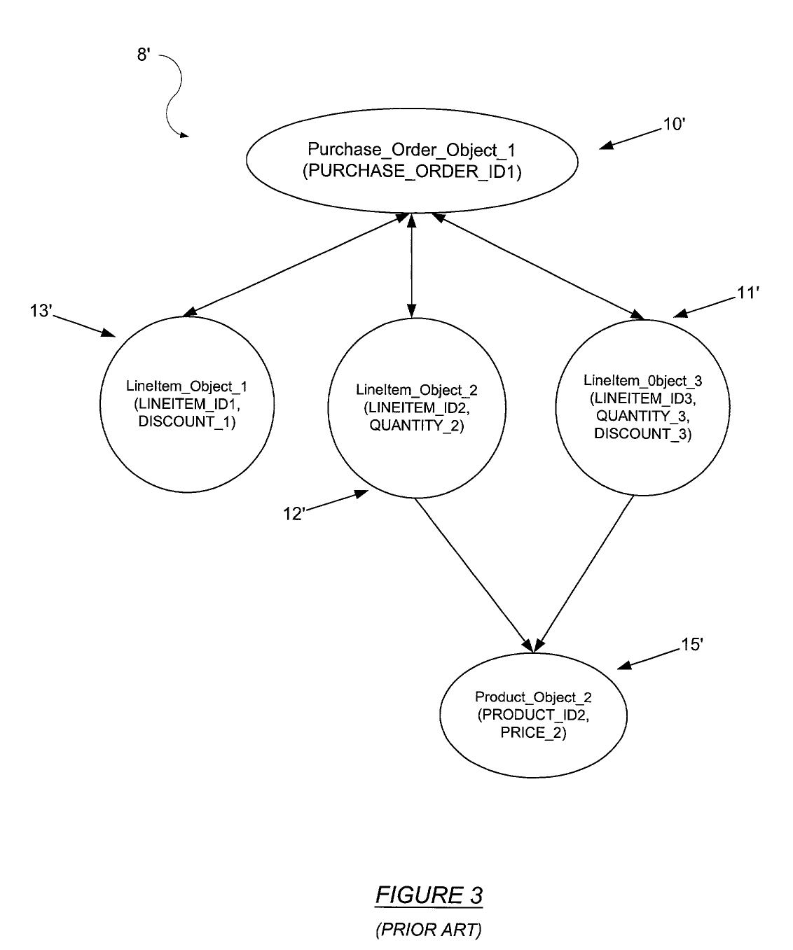

For illustration purposes, Table 1 shows an example of the variable usage specification 22 based on the object graph 8 (shown in FIG. 2). It should be noted that there are a variety of ways of representing the variable usage specification 22, and the format shown in Table 1 is not intended to limit the invention in any way. The variable usage specification 22 references the portions of the object graph 8 (shown in FIG. 2) that are of interest. The references are made relative to the root of the object graph 8 (shown in FIG. 2), which is the Purchase_Order_Object_1 (10 in FIG. 2). Note that the variable usage specification 22 shown in Table 1 corresponds to the object graph 8′ (as illustrated in FIG. 3) which is the trimmed version of the object graph 8 shown in FIG. 2.

TABLE 1
Variable Usage Specification

Purchase_Order.PURCHASE_ORDER_ID
Purchase_Order.LineItems[1].LINEITEM_ID
Purchase_Order.LineItems[1].DISCOUNT
Purchase_Order.LineItems[2].QUANTITY
Purchase_Order.LineItems[3].DISCOUNT
Purchase_Order.LineItems[3].QUANTITY
Purchase_Order.LineItems[3].Product.PRODUCT_ID
Purchase_Order.LineItems[3].Product.PRICE

The transport packager 18 starts by analyzing the variable usage specification 22 and grouping together usages that specify paths to the same object. For example, the usages Purchase_Order.LineItems[3].DISCOUNT and Purchase_Order.Lineltems[3]. QUANTITY both specify a path to the LineItem object_{—}3 (11 in FIG. 2). For each group of usages, the transport packager 18 finds the object whose path is specified in the usage. For the usages Purchase_Order.Lineltems[3].DISCOUNT and Purchase_Order.LineItems[3].QUANTITY, for example, the transporter packager 18 finds the LineItem_Object_3 (11 in FIG. 2). The usages show that LineItem_Object_3 (11 in FIG. 2) is reachable via the Purchase_Order_Object_1 (10 in FIG. 2). Once the LineItem_Object_3 (11 in FIG. 2) is found, the transport packager 18 creates an internal representation of the object using the class information for the LineItem_Object_3 (11 in FIG. 2). For the usages Purchase_Order.LineItems[3].DISCOUNT and Purchase_Order.Lineltems[3].QUANTITY, for example, the DISCOUNT and QUANTITY attributes are set. This process is repeated for the other groups of usages in the variable usage specification 22.

A class is a template describing the fields (variables and constants) and methods that are grouped together to represent a particular object. The class information may be provided to the transport packager 18, as shown at 28, or the transport packager 18 may derive this information at runtime. Java™, for example, provides two mechanisms, reflection and introspection, for discovering information about classes at runtime. These mechanisms can be used to obtain the names of the fields, methods, and constructors in the class. These mechanisms also allow objects to be created at runtime, even though the names of the classes from which the objects will be created are not known until runtime. Typically, the classes from which the objects are instantiated should have a default constructor that does not require arguments so that the object can be instantiated dynamically and its attributes populated in an arbitrary order. The attributes of the object are populated based on the variable usage specification.

In one or more embodiments of the present invention the packaging process may involve writing the state of each object in the object graph to be transported as a sequence of bytes (byte stream) or in some other format suitable for transport or storage, such as XML format. The transport packager 18 preserves complex object graphs in which the same instance appears multiple times. For example, self-referencing graphs are preserved by maintaining the references in the transient object graph representation. In the XML representation, for example, a unique object id is embedded into each object's representation. The transport packager 18 also ensures that duplicate instances are only packaged once for transport, reducing transport size.

In one embodiment, the transport packager 18 is implemented as an interface. One implementation of the interface is called HashtableTransportPackager. In this implementation, the transport packager 18 converts the objects created using the variable usage specification 22 into hash tables. The resulting tree of the hash tables can be serialized, i.e., converted into a sequence of bytes, and transported over a network or stored on disk. Converting the objects into hash tables ensures that duplicate instances are packaged only once for transport or storage. The HashtableTransportPackager interface provides two services, flatten and expand. The flatten service converts objects into hash tables, as described above, and the expand service converts a given hash table into an object.

Another implementation of the interface is called XMLTransportPackager. This interface is useful for interoperability between heterogeneous platforms. The interface creates an XML file that uses the original object and class names. An “id” attribute ensures that duplicate instance references are not written multiple times into the XML file. Like the HashtableTransportPackager interface, the XMLTransportPackager also provides two services called flatten and expand. The flatten service converts objects into XML representation, and the expand service converts the XML representation into objects. The XML representation can be transported over a network without serialization.

Because the transport packager 18 is independent of any particular application, other appropriate implementations of the transport packager interface can be added, such as implementations that produce compressed or encrypted transient object graphs.

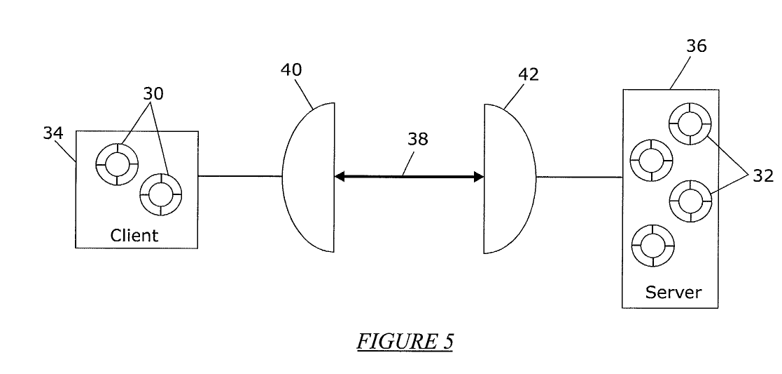

FIG. 5 shows one environment in which the transport packager of the invention may be used. The environment includes distributed objects 30, 32 separated across a client 34 and a server 36, respectively. The client 34 and server 36 run on separate machines and communicate via a network link 38. Two transport packagers 40, 42 are provided, one on the client side and the other on the server side.

The client 34 may invoke a method of one of the objects 32, which may require one or more objects as parameters. The transport packager 40 receives a variable usage specification 22 from the client 34 and trims the object graph containing the object of interest so that only the required data is packaged and transported to the server 36. The transport packager 42 receives the package, unpacks the package, and gives the package to an appropriate one of the objects 32. The appropriate one of the objects 32 executes the method and returns the result to the client 34. If the result includes an object, the transport packager 42 can again package the portion of the object graph that is needed by the client 34 and send the package to the transport packager 40, which unpacks the package and gives the result to the client 34.

The invention provides advantages in that it enables a subset of an object graph to be packaged for transport or storage. The subset of the object graph packaged is based on a variable usage specification, which may be provided by a programmer or generated dynamically by the client. A given object graph can be trimmed by simply invoking the services provided by an interface. This reduces the time required to create transient object graphs and makes the application easier to maintain. Further, the invention prevents excessive amount of data from being transferred over the network because it is based on variable usage specification. Further, the transport packager is independent of any particular application, other appropriate implementations of the transport packager interface can be added, such as implementations that produce compressed or encrypted transient object graphs. Further, the invention employs interfaces, such as XMLTransportPackager, that allow for interoperability between heterogeneous platforms.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for packaging an object graph, comprising:
receiving a usage variable specification that includes a set of usages each usage specifying an attribute of an object in the object graph;
creating a transient object graph representation containing the attribute specified in the variable usage specification; and
packaging the transient object graph representation.

2. The method of claim 1, wherein creating the transient object graph representation comprises identifying an object in the object graph whose attributes are specified in the variable usage specification.

3. The method of claim 2, wherein identifying the object in the object graph comprises receiving a root object in the object graph.

4. The method of claim 3, wherein identifying the object in the object graph further comprises using the root object to find a path to the objects whose attributes are specified in the variable usage specification.

5. The method of claim 2, wherein creating the transient object graph representation further comprises representing the object with the attribute specified in the variable usage specification.

6. The method of claim 5, wherein creating the transient object graph further comprises storing a represented object as a node of the transient object graph.

7. The method of claim 1, further comprising:
converting the transient object graph representation into a form suitable for transport over a network link.

8. The method of claim 1, further comprising:
converting the transient object graph representation into a form suitable for storage on a storage medium.

9. The method of claim 1, further comprising:
converting the transient object graph representation into a byte stream.

10. The method of claim 1, further comprising:
converting the transient object graph representation into a hash table.

11. The method of claim 10, further comprising:
converting the hash table into a byte stream.

12. The method of claim 1, further comprising:
representing the transient object graph representation in a structured language format.

13. The method of claim 1, further comprising:
representing the transient object graph representation in a compressed format.

14. The method of claim 1, further comprising:
representing the transient object graph representation in an encrypted format.

15. A method for packaging an object graph, comprising:
receiving a usage variable specification that includes a set of usages each usage specifying an attribute of an object in the object graph;
creating a transient object graph representation containing the attribute specified in the variable usage specification;
packaging the transient object graph representation; and
converting the transient object graph representation into a form suitable for transport over a network link.

16. A method for packaging an object graph, comprising:
receiving a usage variable specification that includes a set of usages each usage specifying an attribute of an object in the object graph;
creating a transient object graph representation containing the attribute specified in the variable usage specification;
packaging the transient object graph representation; and
converting the transient object graph representation into a form suitable for storage on a storage medium.

17. A transport packager, comprising:
means for receiving a usage variable specification that includes a set of usages each usage specifying an attribute of an object in the object graph;
means for creating a transient object graph representation containing the attribute specified in the variable usage specification; and
means for packaging the transient object graph representation.

18. A computer-readable medium having recorded thereon instructions executable by a processor, the instructions for:
receiving a usage variable specification that includes a set of usages each usage specifying an attribute of an object in the object graph;
creating a transient object graph representation containing the attribute specified in the variable usage specification; and
packaging the transient object graph representation.

19. The computer-readable medium of claim 18, further comprising:
instructions for converting each trimmed object into a form suitable for transport over a network link.

20. The computer-readable medium of claim 18, further comprising:
instructions for converting each trimmed object into a form suitable for storage on a storage medium.

21. A computer-readable medium having recorded thereon instructions executable by a processor, the instructions for:
receiving a usage variable specification that includes a set of usages each usage specifying an attribute of an object in the object graph;
creating a transient object graph representation containing the attribute specified in the variable usage specification;
packaging the transient object graph representation; and
instructions for converting each trimmed object into a form suitable for transport over a network link.

22. A computer-readable medium having recorded thereon instructions executable by a processor, the instructions for:
receiving a usage variable specification that includes a set of usages each usage specifying an attribute of an object in the object graph;
creating a transient object graph representation containing the attribute specified in the variable usage specification;
packaging the transient object graph representation; and
instructions for converting each trimmed object into a form suitable for storage on a storage medium.

23. A distributed system having a client and a server, comprising:
an object generator interposed between the client and the server, the object generator having a capability to trim an object graph such that the trimmed object graph contains only the attributes specified in a variable usage specification; and
means for converting the transient object graph representation into a form suitable for transport over a network link between the client and the server.

24. An apparatus for packaging an object graph, comprising:
means for receiving a usage variable specification that includes a set of usages each usage specifying an attribute of an object in the object graph;
means for creating a transient object graph representation containing the attribute specified in the variable usage specification; and
means for packaging the transient object graph representation.
